(19) United States
(12) Patent Application Publication
(10) Pub. No.: US 2026/0167512 A1
(43) Pub. Date: Jun. 18, 2026

(54) LITHIUM RECOVERY

(71) Applicants: Jonathan GOODMAN, Alexandria (AU); NOVALITH TECHNOLOGIES PTY LIMITED, Alexandria (AU)

(72) Inventors: Andrew HARRIS, Alexandria (AU); Mohammad ASSEFI, Alexandria (AU); Jonathan GOODMAN, Alexandria (AU)

(21) Appl. No.: 19/125,651

(22) PCT Filed: Oct. 31, 2023
(86) PCT No.: PCT/US2023/036474

§ 371 Date: Apr. 29, 2025

(30) Foreign Application Priority Data
Nov. 1, 2022 (AU) 2022903247

(51) Int. Cl. C01D 15/08; B09B 3/35; B09B 3/80; B09B 101/16; C22B 1/248; C22B 3/00; C22B 7/00; C22B 26/12; H01M 10/54

(52) U.S. Cl. CPC C01D 15/08; B09B 3/35; B09B 3/80; C22B 1/248; C22B 7/006; C22B 23/0407; C22B 26/12; H01M 10/54; B09B 2101/16; C01P 2002/72; C01P 2002/82; C01P 2002/85; C01P 2004/03

(57) ABSTRACT

According to the present invention there is provided processes for the recovery of lithium from end-of-life lithium-ion batteries and battery matter. A representative process resides in a process for separating lithium from lithium ion batteries before undertaking hydrometallurgical or pyrometallurgical processing, the process comprising: providing a black mass (BM) or shredded battery material (SBM) that includes cation and anion components; commixing the BM or SBM with an admixture that includes water and supercritical carbon dioxide; and separating an aqueous leachate and a lithium-leached BM or SBM, where the aqueous leachate includes a lithium carbonate and/or bicarbonate.

### CROSS-REFERENCE TO RELATED APPLICATIONS

This disclosure claims the benefit of priority to AU patent application No. 2022903247, filed 1 Nov. 2022, the entirety of which is incorporated herein.

### FIELD OF THE INVENTION

The present invention relates to the recycling of battery materials and/or metals, such as lithium, from end-of-life batteries.

### BACKGROUND

Precious metals are mined from their constituent ores at an exponentially-increasing rate. With the overall supply being strictly finite, some metals are already under supply and sustainability pressure. Without increased adoption of recycling practices, the global supply of certain metals will inevitably extinguish long before consumer demand subsides. One such metal is lithium.

At an industrial level, lithium is assuming ever-increasing popularity given its many uses: ceramics, glasses, batteries, electronics, lubricating greases, metallurgy, pyrotechnics, air purification, optics, polymer chemistry, military applications and medicine—to name but a few. One of the principal uses of lithium is in batteries—and demand will only continue to grow as additional (amongst other emerging technologies) all-electric vehicles take to the roads. Lithium is especially amenable to use in batteries owing to its high electrode potential (the highest of all metals) and its low atomic mass, which leads to high charge-to-weight and power-to-weight ratios. Lithium batteries are preferred over other batteries due to their relatively high charge density (long life), but presently suffer from a relatively high cost per unit. Depending on the design and chemical compounds used, lithium cells can produce voltages from 1.5 V (comparable to a zinc-carbon or alkaline battery) to about 3.7 V.

With an increasing environmental consciousness and demand for battery power as an alternative to fossil fuels comes the inevitability of new waste streams for spent batteries. However, a further inevitability of this mindset working in unison with such waste streams has been a surge in recycling technologies in which, for instance, the valuable lithium contained within spent batteries is recovered and recycled for future use.

It is estimated that by 2030, around 1.2 million tons of lithium ion batteries will have reached end-of-life. This comprises an estimated potential recovery of 125,000 tons of lithium, 35,000 tons of cobalt and 86,000 tons of nickel, which could be recovered for use in new battery production. Such numbers must be considered against the fact that global supply of such elements is strictly finite and absent effective recycling practices, the technology span of lithium ion batteries may be limited by supply rather than by the emergence of new and better battery technologies.

“Black mass” is the industry term used to describe a type of e-waste comprising crushed and shredded end-of-life battery cells. It contains a mixture of valuable metals including lithium, manganese, cobalt, nickel along with graphite and other casing or electrode materials. Initially, waste batteries are collected, sorted, discharged and disassembled. This can be followed by mechanical crushing, drying, sorting sieving and pyrolysis to 700° C. to remove any remaining electrolyte and potentially hazardous to health fluorine-containing components. The resulting material is what is referred to in the battery recycling industry as “black mass”.

In traditional battery recycling, lithium is extracted in the last step or after significant processing. Examples include hydrometallurgy and pyrometallurgy. Hydrometallurgy refers to the extraction of metal by preparing an aqueous solution of a salt of the metal and recovering the metal from the solution. The operations usually involved are leaching, or dissolution of the metal or metal compound in water, commonly with additional agents; separation of the waste and purification of the leach solution; and the precipitation of the metal or one of its pure compounds from the leach solution by chemical or electrolytic means. Common leaching agents include, for example, sulfuric acid, hydrochloric acid and/or hydrogen peroxide. Notably, multiple steps are required and significant wastewater is produced.

Pyrometallurgy refers to the extraction and purification of metals by processes involving the application of heat. The most important operations are roasting, smelting, and refining. Such processes are extremely energy-intensive, consume many environmentally-harmful chemicals and result in the generation of hazardous gasses.

The recovery of lithium by traditional hydrometallurgical or pyrometallurgical means thereby comes at a considerable environmental and consequently financial cost. Unsurprisingly, several alternative technologies have emerged in recent years.

US 2022/0149452, to Northvolt AB, relates to a process for removal of aluminum and iron in the recycling of rechargeable batteries comprising providing a leachate from black mass, adding phosphoric acid to the leachate and adjusting the pH to form iron (III) phosphate and aluminum phosphate, precipitating and removing the formed FePO₄ and AlPO₄, and forming a filtrate for further recovery of cathode metals, mainly NMC-metals (nickel, manganese, cobalt) and lithium.

U.S. Pat. No. 10,919,046, to Li-Cycle Corp, describes an apparatus for carrying out size reduction of battery materials under immersion conditions having a battery inlet and at least a first comminuting device disposed within a housing and configured to cause a size reduction of the battery materials to form reduced-size battery materials and to liberate electrolyte materials and a black mass material comprising anode and cathode powders from within the battery materials. An immersion liquid can be within the housing and can submerge the first comminuting device so the black mass material and the reduced-size battery material are entrained within the immersion liquid to form a sized-reduced feed stream. A feed outlet may be downstream from the first comminuting device.

The COOL-Process (see, e.g., Pavón, et al. The COOL-Process-A Selective Approach for Recycling Lithium Batteries. Metals, 11(2): 259, 2021) is a process for Li recycling from black mass. Depending on the process parameters Li is recovered almost quantitatively making use of the selective leaching properties of supercritical CO₂/water. Optimal reaction conditions are 230° C., 4 h, and a water:black mass ratio of 90 mL/g, yielding 98.6±0.19 wt. % Li. Mainly Li is mobilised, which allows for precipitating Li₂CO₃ (>99.8 wt. %). In addition, about 52% of the initial Al was co-extracted.

A further competitive technology was published recently by RWTH Aachen University (see, e.g., Schwich, et al., Early-Stage Recovery of Lithium from Tailored Thermal Conditioned Black Mass Part I: Mobilising Lithium via Supercritical CO₂-Carbonation. Metals, 11(2): 177, 2021), and focuses on early-stage lithium recovery. Full NCM-based electric vehicle cells are thermally treated to recover heat-treated black mass. Then, the heat-treated black mass is subjected to an H₂O-leaching step to examine the share of water-soluble lithium phases. This is compared to a carbonation treatment with supercritical CO₂, where a higher extent of lithium from the heat-treated black mass can be transferred to an aqueous solution than by H₂O-leaching alone. Key factors on the lithium yield include the filter cake purification, the lithium separation method, the solid/liquid ratio, the pyrolysis temperature and atmosphere, and the setup of autoclave carbonation, which can be performed in an H₂O-environment or in a dry autoclave environment. In this approach, treatment with supercritical CO₂ in an autoclave reactor leads to lithium yields of up to 79%.

TABLE 1
Summary of the prior art processes described above

| | | | | RWTH |
|---|---|---|---|---|
| | Li-Cycle | Northvolt | Cool- | Aachen |
| | Corp | AB | Process | University |
| Process type | Multi-step | Multi-step | Batch | Batch |
| Chemicals | Acids, | Acids, | CO₂ and H₂O | CO₂ and H₂O |
| | bases, | bases, | | |
| | organics | organics | | |
| Reactor type | — | — | Hydrothermal | Hydrothermal |
| Physical/ | Acids and | Acids and | Al removal | Al removal |
| chemical | bases | bases | | |
| pre-treatment | | | | |

Having regard to Table 1, above, it can be seen that the new wave of technologies described above still suffer from one or more of energy intensity, chemical usage and pre-treatment requirements. On the above bases, it is unexpected that black mass could be used directly in a process to extract lithium.

It is an object of the present invention to overcome or ameliorate at least one of the disadvantages of the prior art, or to provide a useful alternative. It is an object of a particularly preferred form of the present invention to provide a relatively simple, convenient and effective means of extracting lithium from spent or end-of-life lithium ion batteries. Although the invention will be described with reference to specific examples it will be appreciated by those skilled in the art that the invention may be embodied in many other forms.

### SUMMARY

A first embodiment is a process for separating lithium from lithium ion batteries before undertaking hydrometallurgical or pyrometallurgical processing, the process includes providing a black mass (BM) or shredded battery material (SBM) that includes cation and anion components; commixing the BM or SBM with an admixture that includes water and supercritical carbon dioxide; and separating an aqueous leachate and a lithium-leached BM or SBM, where the aqueous leachate includes a lithium carbonate and/or bicarbonate.

A second embodiment is a process that includes comminuting a plurality of lithium-ion cells in water thereby providing a slurry that includes a black mass (BM) or shredded battery material (SBM) and water; commixing the slurry with supercritical carbon dioxide; and separating an aqueous leachate and a lithium-leached BM or SBM, where the aqueous leachate includes a lithium carbonate and/or bicarbonate.

A third embodiment is a process that includes comminuting a plurality of lithium-ion cells in a solution of water and carbon dioxide thereby providing a slurry that includes a black mass (BM) or shredded battery material (SBM), lithium bicarbonate, water, and carbon dioxide; and separating an aqueous leachate from the BM or SBM, where the aqueous leachate includes the lithium bicarbonate.

A fourth embodiment is a method for the extraction of one or more materials from black mass (BM) end-of-life battery waste, the method can include obtaining the black mass having a content of the one or more materials; subjecting the BM to an aqueous extraction medium defined by a reactor, a predetermined partial pressure of CO₂, a predetermined extraction temperature, and a predetermined residence time; and obtaining at least one of the one or more materials in solution therefrom.

A fifth embodiment is an apparatus for the extraction of one or more materials from black mass (BM) end-of-life battery waste, the apparatus includes a means for subjecting the black mass to an aqueous extraction medium defined by a fluidised bed reactor, a predetermined partial pressure of CO₂, a predetermined extraction temperature, and a predetermined residence time; and a means for obtaining at least one of the one or more materials in solution therefrom.

### BRIEF DESCRIPTION OF THE FIGURES

For a more complete understanding of the disclosure, reference should be made to the following detailed description and accompanying drawing figures wherein:

FIG. 1 is a schematic of a hydrometallurgical recovery process as known in the prior art. Hydrometallurgical processes are characterised by necessary pre-treatment, the use of harsh chemicals and the extraction of lithium as the final (or near-final) step of the process.

FIG. 2 is a schematic of the COOL-Process as known in the prior art. This is a selective process for lithium recycling from black mass. Optimal reaction conditions are 230° C., 4 h, and a water:black mass ratio of 90 mL/g, yielding 98.6±0.19 wt. % Li. Mainly Li (>99.8 wt. %) and Al (≥52 wt. %) are mobilised.

FIG. 3 is a schematic of the process according to the present invention. The process comprises obtaining a black mass having a lithium content; subjecting the black mass to an aqueous extraction medium defined by a fluidised bed reactor, a predetermined partial pressure of CO₂, a predetermined extraction temperature, and a predetermined residence time; and obtaining technical grade lithium carbonate/lithium bicarbonate in solution therefrom. In the inventive process, the aluminum (and indeed, the other metals) have not been removed from the black mass, nor is it co-extracted with the lithium as it would be in, for example, the COOL-Process.

FIG. 4 is a photograph of a fluidised bed reactor as employed during testing of the present invention on a laboratory scale.

FIG. 5 is an image of a sample of lithium carbonate extracted from black mass via the present inventive process. The slight green coloration on the product is due to a small amount of nickel impurity.

FIG. 6 is a plot of concentration versus time for a laboratory scale run of the present inventive process. It can be seen that lithium is most efficiently extracted around 10-60 min, with decreased returns from 60-150 min. Moreover, relatively few impurities are extracted over the initial 60 min period, meaning that the extracted lithium can be achieved relatively quickly and in relatively high purity. By comparison, beyond about 140 min, nickel is the primary element extracted, in about a 2:1 ratio with lithium and about 15:1 with cobalt.

FIG. 7 is a plot showing the extent of extraction versus time. It compares the extraction efficiency of lithium over nickel and cobalt. The data reveal that by about 140 min, 92 wt. % of the lithium has been selectively extracted in comparison to 5 wt. % and 1 wt. % for nickel and cobalt, respectively.

FIG. 8 shows the FT-IR spectrum of standard lithium carbonate in comparison to the extracted material through the inventive process. The absorption peak at 477 cm⁻¹ is attributed to the stretching vibration of Li—O. The peaks ranging from 858, 1087 and 1411 cm⁻¹ are identified as stretching and bending of the CO₃²⁻ group. The FT-IR analysis shows that the spectrum of the extracted green material is in good agreement with the spectrum of standard lithium carbonate, confirming its chemical structure.

FIG. 9 presents the sieve sizing of the black mass sample subjected to the inventive process as a function of weight percentage. As data indicate the majority of the sample is in sizes ranging from 75-425 μm.

FIG. 10 shows the crystal structure of cathode materials determined by X-ray diffraction (XRD) analysis. By referring to the XRD patterns of the standard samples listed in Table 3, all diffraction peaks could be indexed to four different phases. The high intensity peaks are in good agreement with the standard data suggesting that the two main phases could be aluminum and lithium nickel cobalt oxide.

FIGS. 11A-D compare the scanning electron microscopy (SEM) images and energy-dispersive X-ray spectroscopy (EDS) analysis of the raw black mass before and after the extraction process. SEM and EDS results of the raw black mass before extraction (FIG. 11A and Figure B) indicate the Al is located at the center and has been covered on both sides with Li-bearing materials. FIG. 11C and FIG. 11D display the post-extraction materials as amorphous materials with no particular shape. The SEM and EDS results confirm that the extraction process has resulted in deformation of the raw materials layer structure and extraction of Li bearing materials.

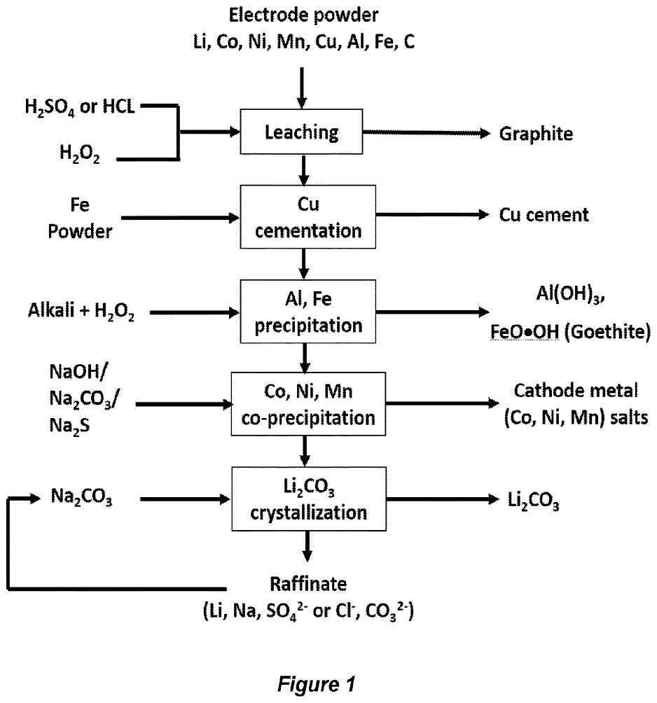

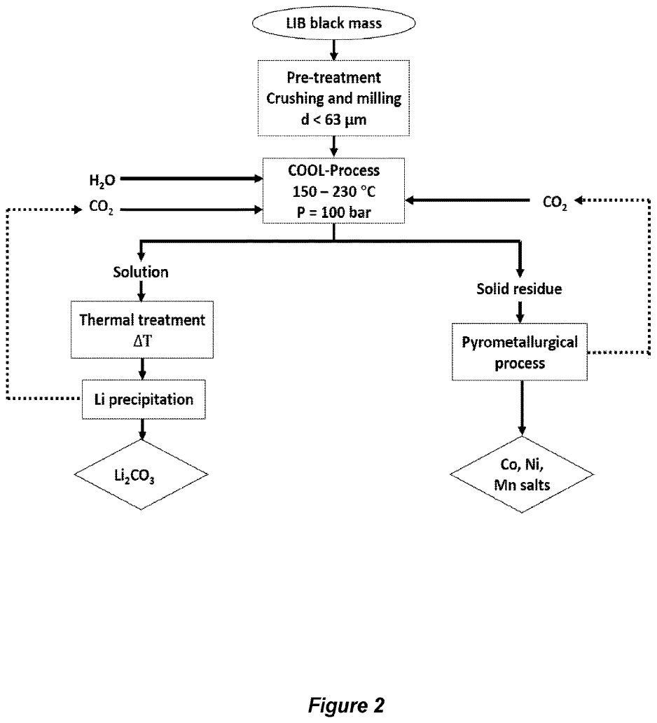

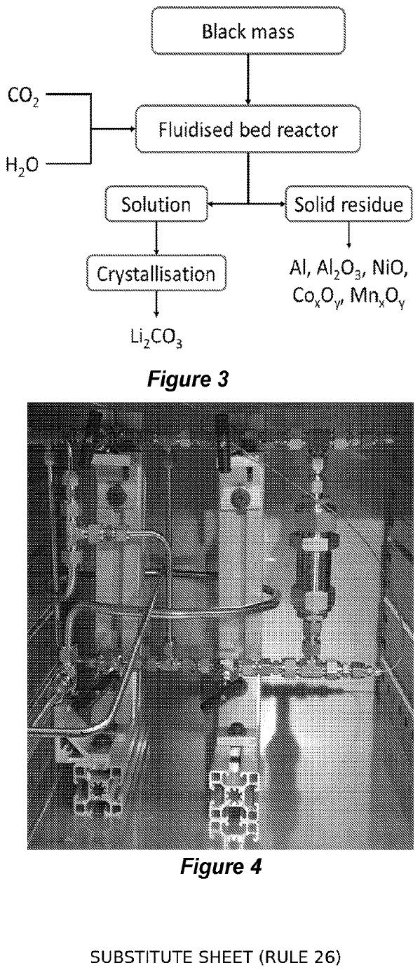

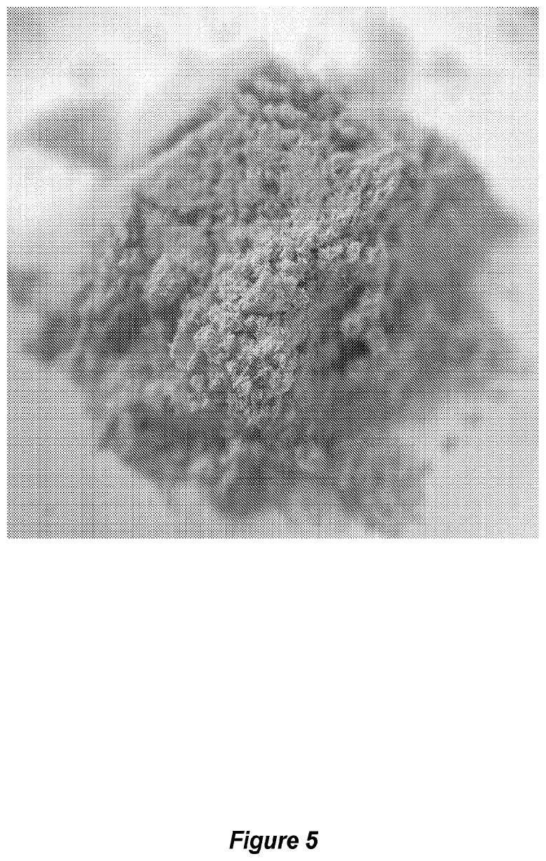

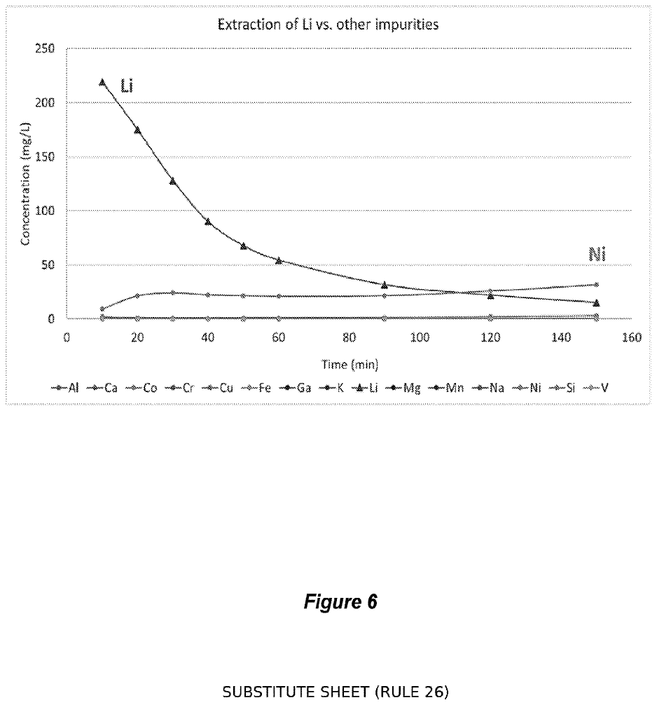

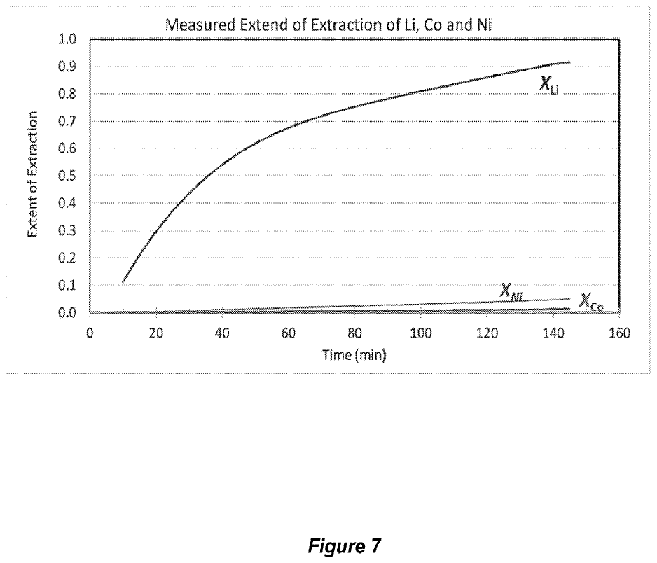

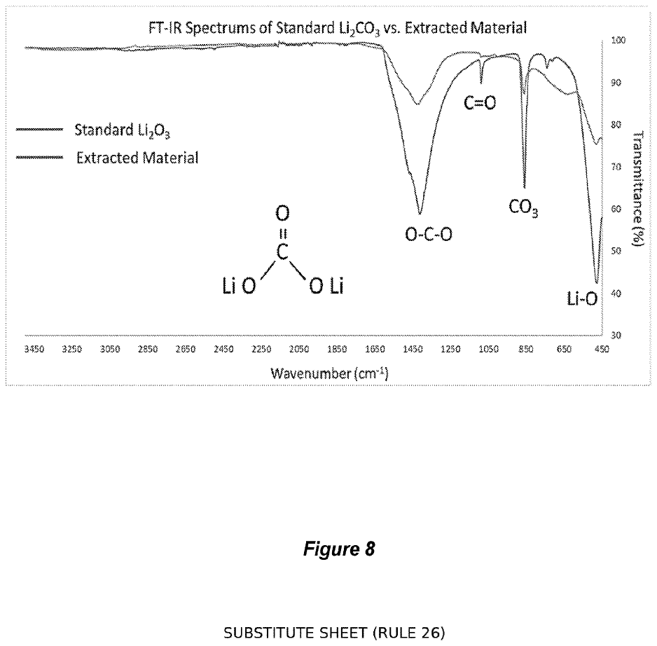

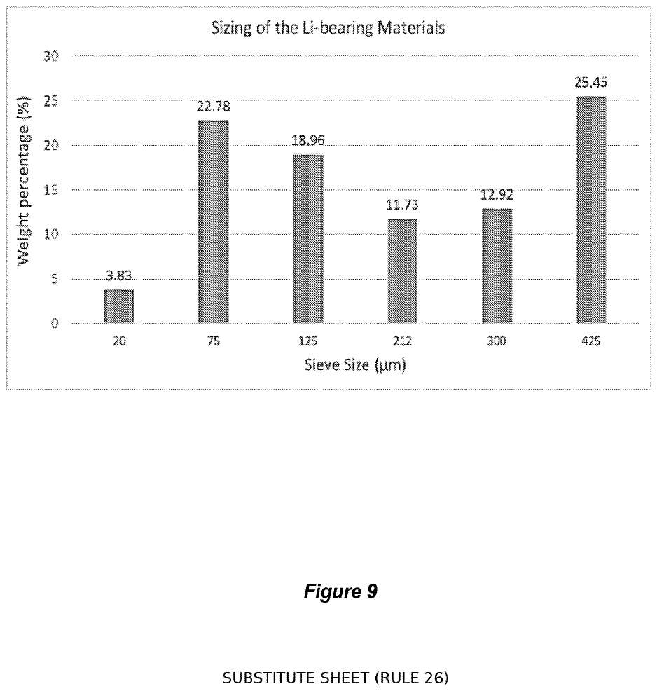

While specific embodiments are illustrated in the figures, with the understanding that the disclosure is intended to be illustrative, these embodiments are not intended to limit the invention described and illustrated herein.

### DETAILED DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternatives are mutually exclusive, although the disclosure supports a definition that refers to only alternatives and “and/or.”

As used herein, the term “shredded battery material” or SBM refers to material generated by the shredding, comminution, or other reduction of a lithium-ion battery cell to a particulate material. In some cases, the lithium-ion battery cell may have been removed from any packaging, housing, or other material that may have housed the cell or cells. SBM typically refers to lithium-ion battery cells that have been shredded, comminuted, pulverised, shattered, fragmented, crushed, splintered, or otherwise reduced into small particulate materials. The SBM may be formed from end of life batteries or batteries that have failed testing/not passed quality control. The SBM may be formed from the same type of battery or from different types of batteries, provided all such batteries comprise lithium.

The term “black mass” refers, generally, to the particulate material generated from recycled lithium-ion cathodes. As used herein, black mass is the shredded, comminuted, or particulate material generated predominantly or entirely from a lithium-ion battery cathode. In preferable instances, black mass is the “raw” black mass of the cathode materials which typically comprises binders, lithium metal oxides and aluminum. At times, the terms black mass and raw black mass can be used interchangeably but the herein presented invention is applicable to both materials that include aluminum and binders (typically the raw black mass) and materials wherein aluminum and binder has been separated therefrom (refined black mass or just black mass).

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

A first embodiment is a process for separating lithium from lithium ion batteries before undertaking hydrometallurgical or pyrometallurgical processing. This process can include providing a black mass (BM) or shredded battery material (SBM) that includes cation and anion components; commixing the BM or SBM with an admixture that includes water and supercritical carbon dioxide; and separating an aqueous leachate and a lithium-leached BM or SBM, where the aqueous leachate includes a lithium carbonate and/or bicarbonate. Herewith, hydrometallurgical and pyrometallurgical processes have their common meanings and are known to those of ordinary skill in the art. The BM or SBM is, preferably, the product of mechanically shredding one or more lithium ion batteries. Accordingly, the process can include providing the BM or SBM, by, for example, providing lithium ion batteries; mechanically shredding the lithium ion batteries to produce a BM or SBM; and optionally mechanically separating casing materials from the SBM. Herewith, casing materials can include plastic, metal, or metalised plastic within which the anode and cathode are contained.

In certain instances, the BM or SBM includes at least two of a shredded cathode material, a shredded anode material, electrolyte salts, and solid electrolyte interphase (SEI) material. In certain instances, the BM includes a shredded cathode material. In a preferred example, the SBM includes SEI material. SEI is often composed of both organic and inorganic products from electrolyte decomposition. The SEI material can include amorphous layers of Li₂CO₃, LIF, Li₂O, polyolefins, semicarbonates, and mixtures thereof. In another preferred example, the SBM includes shredded cathode material (SCM) and shredded anode material (SAM). The SCM can include iron, nickel, manganese, cobalt, or mixtures thereof. In a particularly preferable instance, the SCM includes nickel. The SCM can further include aluminum from the cathodic current collector. The SAM typically includes graphite but in instances wherein the cell is a lithium-metal cell or anodeless cell, the anode material can be free of graphite. The SAM can further include copper from the anodic current collector. In rare examples of lithium metal cells, the SAM may be free of copper and consist essentially of lithium metal and its alloyed components.

Notably, the BM or SBM includes a lithium mass, that is the lithium content of the lithium ion cell prior to shredding. In a particularly preferable instance, the aqueous leachate separated from the commixed BM or SBM and water/supercritical carbon dioxide admixture includes at least 75%, 80%, 85%, 90%, or 95% of the lithium mass.

In certain instances, the process uses SBM in the process.

In certain instances, the process uses BM in the process.

The process can further include crystallising and, optionally, then recrystallising lithium carbonate from the aqueous leachate. Herewith crystallisation of the lithium carbonate is process generally known in the art and is often driven by the inverse solubility in hot water of lithium carbonate to other aqueous species. Accordingly, the lithium carbonate can be crystallised by heating the aqueous leachate and precipitating the lithium carbonate. In other instances, the crystallisation can be driven by other processes known in the art including adding an antisolvent.

The process can further include concentration steps to increase the concentration of the lithium carbonate from the aqueous leachate. Herewith concentration steps typically require the removal of the solvent, such as water, from the leachate in which the lithium carbonate is present. Methods of removal of solvents and concentrating solutions are known to those of skill in the art and include such methods as use of a concentrator, evaporation, reverse osmosis and/or electrodialysis, liquid-liquid extraction, selective adsorption and solid state extraction and/or membrane separation alone or in combination. The concentration of the leachate may be necessary to facilitate crystallising or recrystallising the lithium carbonate from the aqueous solvent.

Importantly, the process preferably provides a lithium-leached BM or SBM that is substantially free of lithium. In certain examples the lithium-leached BM or SBM includes less than 25%, 20%, 15%, 10%, or 5% of the lithium included in the SBM (the lithium mass).

In another example, the BM or SBM and the water/supercritical carbon dioxide admixture are commixed at a temperature of about 80° C. to about 200° C. and at a pressure of about 70 bar to about 250 bar. The temperature can be of about 80° C. to about 150° C. and the pressure of about 85 bar to about 150 bar; or the temperature can be of about 100° C. to about 200° C. and the pressure of about 85 bar to about 125 bar. Such temperatures may include 80, 90, 100, 110, 120, 130, 140, 150, 160, 170, 180, 190 and about 200° C., including intermediate temperatures. Such pressures may include 70, 80, 90, 100, 110, 120, 130, 140, 150, 160, 170, 180, 190, 200, 210, 220, 230, 240 and about 250 bar, including intermediate pressures.

The process can further include hydrometallugically separating nickel from the lithium-leached SBM. Alternatively, the process can further include pyrometallugically separating nickel from the lithium-leached SBM. Both hydro- and pyrometallurgical processes are performed according to standard techniques of the art.

Pursuant to the Exemplary Process, casings can be removed from a plurality of nickel-manganese-cobalt (NMC) based lithium ion batteries and the cells comminuted, thereby providing shredded battery material (SBM). Then the SBM can be mixed with supercritical CO₂ and water in a fluidised bed reactor, in which the temperature and pressure of the system can be maintained at about 150° C. and 100 bar. The temperature can be in a range of 120 to 180° C., which includes 120, 125, 130, 135, 140, 145, 150, 155, 160, 165, 170, 175, 180° C., including intermediary values such as 141, 142, 143, 144, 146, 147, 148, 149, 151, 152, 153, 154, 156, 157, 158 and 159° C., etc. The pressure can be in a range of 80 to 120 bar, which includes 80, 85, 90, 95, 100, 105, 110, 115 and about 120 bar, including intermediary values such as 90, 91, 92, 93, 94, 95, 96, 97, 98, 99, 100 bar, etc.

The extract can be removed from the system until the lithium concentration in the filtrate (extract) is below about 10 ppm, such as about 9, 8, 7, 6, 5, 4, 3, 2, 1 ppm. Accordingly, about 90% of the lithium in the NMC based lithium ion batteries can be recovered. Variations in the temperature and pressure of the system (from 100° C. to 200° C. and from 80 bar to 150 bar) provided analogous results. In multiple experiments, ICP analysis of residues from the fluidised bed reactor showed less than 10% of the original lithium concentrations.

A second embodiment is a process that includes comminuting a plurality of lithium-ion cells in water thereby providing a slurry that includes a black mass (BM) or shredded battery material (SBM) and water. The process then includes commixing the slurry with supercritical carbon dioxide; and separating an aqueous leachate and a lithium-leached BM or SBM. Preferably, the aqueous leachate includes a lithium carbonate and/or bicarbonate. In a particularly preferred instance, the process is continuous.

The process can further include crystallising lithium carbonate from the aqueous leachate (as described above); and separating the crystallised lithium carbonate from the aqueous leachate. The separation of the crystallised lithium carbonate can be accomplished by filtration or centrifugation in a continuous or batch process. In one instance, the filtration is accomplished with a nutsche filter press, in another instance, the centrifugation is accomplished with a continuous centrifuge. Other processes and equipment are known to those of ordinary skill in the separation art. In a particularly preferable instance, the aqueous leachate is recycled and used in the comminution of the lithium-ion cells. That is, the plurality of lithium-ion cells are comminuted in a mixture of the aqueous leachate and water. This recycling process (a part of a continuous process) can reduce the water necessary for the overall process and improve the lithium recovery.

In a preferable instance, the supercritical carbon dioxide phase is separated from the slurry and the supercritical carbon dioxide phase includes at least one of an organic electrolyte and an organic polymer (optionally a binder or separator). In one example, the supercritical carbon dioxide phase includes the organic electrolyte (from the lithium-ion cell) which can include at least one of ethylene carbonate, fluoroethylene carbonate, propylene carbonate, and glycol. In another example the supercritical carbon dioxide phase includes the organic polymer which includes polyvinylidene fluoride (PVDF), polystyrene-butadiene rubber (SBR), carboxymethyl cellulose (CMC), a separator polymer, or mixtures thereof, e.g., CMC-SBR.

The plurality of lithium-ion cells can be comminuted in an admixture of water and carbon dioxide, thereby providing a slurry that includes a black mass (BM) or shredded battery material (SBM), water, and carbon dioxide. Preferably, the admixture is water saturated with carbon dioxide (according to Beer's law) but the concentration of carbon dioxide in the water can be below saturation. In one instance, the lithium-ion cells can be comminuted at about 1 atm (standard pressure in an open container) alternatively the cells can be comminuted at a positive pressure up to about 15 bar. Notably, comminution at a positive pressure can displace oxygen and reduce the likelihood of combustion during comminution.

A third embodiment is a process that includes comminuting a plurality of lithium-ion cells in a solution of water and carbon dioxide thereby providing a slurry that includes a black mass (BM) or shredded battery material (SBM), lithium bicarbonate, water, and carbon dioxide. The process further includes separating an aqueous leachate from the SBM, where the aqueous leachate includes the lithium bicarbonate. Herewith, the comminution of the lithium-ion cells includes the reaction of lithium within the cells with water. That is, the process includes reacting lithium metal, lithium-carbon (LiC₆), or other species common to a charged lithium-ion cell with water and/or carbonic acid. The process can include forming a lithium hydroxide by the reaction of lithium with water, forming lithium bicarbonate by the reaction of lithium with carbonic acid, and/or forming lithium bicarbonate by the reaction of lithium hydroxide with carbon dioxide or carbonic acid. In a preferable instance, the solution of water and carbon dioxide is substantially free of oxygen; even more preferably, the partial pressure of oxygen above the solution is too low to support combustion of hydrogen and/or an organic component from the lithium-ion cells.

The process can further include commixing the slurry with supercritical carbon dioxide; and then separating an aqueous leachate and a lithium-leached BM or SBM, where the aqueous leachate includes a lithium carbonate and/or bicarbonate. That is, the lithium-ion cells are comminuted in a carbonated solution (carbonated water) and then the resulting slurry is commixed with supercritical carbon dioxide. In one instance, organic and fluorinated materials in the slurry are solvent extracted (into the supercritical carbon dioxide) and recovered. In one example, the supercritical carbon dioxide is passed through the slurry to recover the organic and fluorinated materials; and thereafter the aqueous leachate is separated from the lithium-leached BM or SBM. Lithium carbonate is, preferably, then recovered from the aqueous leachate.

In another instance, the process can further include commixing the BM or SBM with a second solution that includes water and supercritical carbon dioxide; and then separating an aqueous leachate and a lithium-leached BM or SBM, where the aqueous leachate includes a lithium carbonate and/or bicarbonate. That is, the slurry obtained from the comminution of the lithium-ion cells can be added to a reactor (e.g., a fluidised bed reactor or a packed bed reactor) and the second solution passed through the reactor. The passed through solution can then be separated into an aqueous leachate and a supercritical carbon dioxide leachate or the passed through solution can be depressurised (preferably with carbon dioxide recovery). Thereafter, lithium carbonate can be recovered from the aqueous leachate.

Another embodiment is a method for the extraction of one or more materials from black mass end-of-life battery waste, the method includes the steps of: a) obtaining the black mass having a content of the one or more precious metals; b) subjecting the black mass to an aqueous extraction medium defined by a reactor, a predetermined partial pressure of CO₂, a predetermined extraction temperature, and a predetermined residence time; and c) obtaining the one or more materials in solution therefrom. Preferably, the one or more materials comprise one or more precious metals. The one or more precious metals include Ag, Au, Li, Al, Ca, Cr, Co, Cu, Fe, Ga, K, Mg, Mn, Na, Ni and V. Preferably, the one or more precious metals include Li, Co, and Ni; more preferably, the one or more precious metals includes lithium.

The black mass can further include one or more precious materials, for example, a binder or electrolyte. Preferably, the electrolyte is lithium hexafluorophosphate (LiPF₆) and the binder is selected from one or more of fluoroethylene carbonate (FEC), 1,3-propane sultone (PS), dimethyl carbonate (DMC), ethyl methyl carbonate (EMC), ethylene carbonate (EC), polyvinylidene fluoride (PVDF) or propylene carbonate (PC).

Step b) can further include the addition of one or more chelating agents. The chelating agents may be used to preferentially extract precious metals other than lithium, such as Ag, Au, Al, Ca, Cr, Co, Cu, Fe, Ga, K, Mg, Mn, Na, Ni and V, preferably Ni and Co. The chelating agents can be selected from one or more of tri-n-butyl phosphate (TBP), nitric acid, sodium hydroxide, hydrogen peroxide, diethanolamine (DEA), 2-ethylhexyl phosphonic acid-mono-2-ethylhexyl ester, mono-2-ethylhexyl(2-Ethylhexyl)phosphonate (PC88A), di-(2-ethylhexyl)phosphoric acid (D2EHPA), bis(2,4,4-trimethylpentyl)phosphinic acid (Cyanex 272), or bis(2,4,4-trimethylpentyl)dithiophosphinic acid (Cyanex 301).

The methods herein can be performed on a continuous or semi-continuous basis. Semi-continuous operation may involve a batch-type process whereby each batch is run in a semi-continuous process. This could be achieved in a plurality of reactors each operating independently of the other or in fluid communication with each other such that each batch is run with an increasing concentration of lithium in solution as it is passed through each reactor. The term “batch” should be understood to include fixed bed, fluidised bed or moving bed reactors. The method can employ a plurality of fluidised bed reactors arranged in series or arranged in parallel.

In certain instances, the BM or SBM and the admixture that includes water and supercritical carbon dioxide are commixed at a predetermined extraction temperature and a predetermined partial pressure for a predetermined residence time.

Predetermined partial pressures of carbon dioxide can be between about 0.1 and about 300 bar; between about 1 and about 250 bar; between about 5 and about 225 bar; between about 10 and about 200 bar; between about 25 and about 175 bar; between about 50 and about 150 bar; between about 75 and about 125 bar; between about 80 and about 120 bar; between about 85 and about 115 bar; between about 90 and about 110 bar; or between about 95 and about 105 bar. In another instance, the predetermined partial pressure of carbon dioxide can be between about 0.1 and about 300 bar; between about 0.1 and about 250 bar; between about 0.1 and about 225 bar; between about 0.1 and about 200 bar; between about 0.1 and about 175 bar; between about 0.1 and about 150 bar; between about 0.1 and about 125 bar; between about 0.1 and about 120 bar; between about 0.1 and about 115 bar; between about 0.1 and about 110 bar; or between about 0.1 and about 105 bar. In still another instance, the predetermined partial pressure of carbon dioxide can be between about 0.1 and about 300 bar; between about 1 and about 300 bar; between about 5 and about 300 bar; between about 10 and about 300 bar; between about 25 and about 300 bar; between about 50 and about 300 bar; between about 75 and about 300 bar; between about 80 and about 300 bar; between about 85 and about 300 bar; between about 90 and about 300 bar; between about 95 and about 300 bar. In another preferred instance, the predetermined partial pressure of CO₂ is about 100 bar.

The predetermined extraction temperature can be between about 20° C. and about 350° C. This defined range encompasses the stated endpoints and all temperatures therebetween. As such, the claimed range includes extraction temperatures of 20, 25, 30, 35, 45, 50, 55, 60, 65, 70, 75, 80, 85, 90, 95, 100, 105, 110, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, and 350° C., including intermediary values such as 141, 142, 143, 144, 146, 147, 148, 149, 151, 152, 153, 154, 156, 157, 158 and 159° C., etc. In a preferred instance, the predetermined extraction temperature is between about 20° C. and about 350° C.; about 40° C. and about 300° C.; about 60° C. and about 250° C.; about 80° C. and about 200° C.; about 100° C. and about 190° C.; about 120° C. and about 180° C.; about 130° C. and about 170° C.; or about 140° C. and about 160° C. In another preferred instance, the predetermined extraction temperature is about 150° C. In another instance, the predetermined extraction temperature is between about 20° C. and about 350° C.; about 20° C. and about 300° C.; about 20° C. and about 250° C.; about 20° C. and about 200° C.; about 20° C. and about 190° C.; about 20° C. and about 180° C.; about 20° C. and about 170° C.; or about 20° C. and about 160° C. In still another instance, the predetermined extraction temperature is between about 20° C. and about 350° C.; about 40° C. and about 350° C.; about 60° C. and about 350° C.; about 80° C. and about 350° C.; about 100° C. and about 350° C.; about 120° C. and about 350° C.; about 130° C. and about 350° C.; or about 140° C. and about 350° C.

The aqueous extraction medium can include a black mass concentration between about 0.1 and about 60% w/w. The black mass concentration equates to the weight/weight percentage of solids within the aqueous (i.e., water) solution. The predetermined solids concentration is between about 0.1% w/w and about 60% w/w. As such, the claimed range includes 0.1, 1, 2, 4, 6, 8, 10, 12, 14, 16, 18, 20, 22, 24, 26, 28, 30, 32, 34, 36, 38, 40, 42, 44, 46, 48, 50, 52, 54, 56, 58 and 60% w/w, including intermediary values such as 21, 23, 25, 27, 29, 31, 33, 35, 37 and 39% w/w. The predetermined solids concentration can be between about 0.1 and about 60% w/w; about 1 and about 55% w/w; about 5 and about 50% w/w; about 10 and about 40% w/w; about 20 and about 35% w/w; or about 30% w/w. In another instance, the predetermined solids concentration is between about 0.1 and about 60% w/w; about 0.1 and about 55% w/w; about 0.1 and about 50% w/w; about 0.1 and about 40% w/w; or about 0.1 and about 35% w/w. In still another instance, the predetermined solids concentration is between about 0.1 and about 60% w/w; about 1 and about 60% w/w; about 5 and about 60% w/w; about 10 and about 60% w/w; or about 20 and about 60% w/w.

The BM or SBM can have an average particle size between about 0.1 μm and about 1000 μm. In a preferred instance, the black mass has an average particle size between about 20 μm and about 425 μm. Without wishing to be bound by theory, it is believed that smaller particle sizes tend toward lithium, cobalt and nickel extraction or other precious metals with a similar molecular size and/or chemical valence, whereas larger black mass particles provide for the selective extraction of other metals such as aluminum.

Preferably, the average particle size of the BM or SBM is between about 0.1 μm and about 1000 μm, more preferably, between about 20 μm and about 425 μm. The claimed range includes 0.1, 1, 20, 40, 60, 80, 100, 120, 140, 160, 180, 200, 220, 240, 260, 280, 300, 320, 340, 360, 380, 400, 420, 440, 460, 480, 500, 520, 540, 560, 580, 600, 620, 640, 660, 680, 700, 720, 740, 760, 780, 800, 820, 840, 860, 880, 900, 920, 940, 960, 980 and 1000 μm, including intermediary values such as 61, 62, 63, 64, 65, 66, 67, 68, 69, 70, 71, 72, 73, 74, 75, 76, 77, 78, 79, 81, 82, 83, 84, 85, 86, 87, 88, 89, 90, 91, 92, 93, 94, 95, 96, 97, 98 and 99 μm.

In one instance, the average particle size of the BM or SBM is between about 0.1 μm and about 1000 μm; about 1 μm and about 800 μm; about 5 μm and about 600 μm; about 10 μm and about 600 μm; about 20 μm and about 400 μm; about 30 μm and about 200 μm; about 40 μm and about 150 μm; or about 50 μm and about 100 μm. In another instance, the predetermined average particle size is about 20 μm to about 425 μm. In still another instance, the average particle size of the black mass is between about 0.1 μm and about 1000 μm; about 0.1 μm and about 800 μm; about 0.1 μm and about 600 μm; about 0.1 μm and about 600 μm; about 0.1 μm and about 400 μm; about 0.1 μm and about 200 μm; about 0.1 μm and about 150 μm; about 0.1 μm and about 100 μm. In yet another instance, the average particle size of the black mass is between about 0.1 μm and about 1000 μm; about 1 μm and about 1000 μm; about 5 μm and about 1000 μm; about 10 μm and about 1000 μm; about 20 μm and about 1000 μm; about 30 μm and about 1000 μm; about 40 μm and about 1000 μm; about 50 μm and about 1000 μm.

The predetermined residence time can be between about 1 and about 1000 minutes. More preferably, the predetermined residence time is between about 60 and about 180 minutes. More preferably still, the predetermined residence time is about 120 minutes. The predetermined time, of course, depends upon the combination of the other parameters adopted (partial pressure of CO₂, temperature, pressure, average particle size of the black mass). As such, the predetermined time will be the time in which the reaction goes to completion or substantial completion (˜85% completion observed for the exemplary extraction provided below) for a given combination of the above four parameters. This defined range is intended to encompass the stated endpoints and all time periods therebetween. As such, the claimed range includes 1, 5, 10, 15, 20, 25, 30, 35, 45, 50, 55, 60, 65, 70, 75, 80, 85, 90, 95, 100, 105, 110, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995 and 1000 minutes, including intermediary values such as 452, 454, 456, 458, 462, 464, 466, 468, 472, 474, 476, 478, 482, 484, 486, 488, 492, 494, 496, 498, 502, 504, 506, 508, 512, 514, 516, 518, 522, 524, 526, 528, 532, 534, 536, 538, 542, 544, 546 and 548 minutes.

In a preferred instance, the predetermined residence time is about 60, 70, 80, 90, 100, 110, 120, 130, 140, 150, 160, 170, or about 180 minutes; preferably about 90, 95, 100, 105, 110, 115, 120, 125, 130, 135, 140, 145 or about 150 minutes. In another instance, the predetermined time is between about 1 and about 1000 minutes; between about 100 and about 900 minutes; between about 150 and about 800 minutes; between about 175 and about 700 minutes; between about 200 and about 600 minutes; between about 220 and about 500 minutes; between about 240 and about 450 minutes; between about 260 and about 400 minutes; between about 280 and about 350 minutes; between about 290 and about 320 minutes; or about 300 minutes. In still another instance, the predetermined time is between about 1 and about 1000 minutes; between about 1 and about 950 minutes; between about 1 and about 900 minutes; between about 1 and about 850 minutes; between about 1 and about 800 minutes; between about 1 and about 750 minutes; between about 1 and about 700 minutes; between about 1 and about 650 minutes; between about 1 and about 600 minutes; or between about 1 and about 550 minutes. In still yet another instance, the predetermined time is between about 1 and about 1000 minutes; between about 50 and about 1000 minutes; between about 100 and about 1000 minutes; between about 150 and about 1000 minutes; between about 200 and about 1000 minutes; between about 250 and about 1000 minutes; between about 300 and about 1000 minutes; between about 350 and about 1000 minutes; between about 400 and about 1000 minutes; between about 450 and about 1000 minutes; or about 120 minutes. In an especially preferred instance, the predetermined time is about 90 minutes to about 150 minutes; more preferably, the predetermined time is about 120 minutes. Alternatively, the predetermined time can be about 60, 70, 80, 90, 100, 110, 120, 130, 140, 150, 160, 170, or about 180 minutes.

The inventive method gives rise to a yield (on an extracted lithium basis) of between about 1% and about 99%; preferably the yield is greater than about 50%, 75%, 85%, 90%, or 95%.

In an instance, one or more impurities extracted from the BM or SBM comprise Ag, Au, Na, Co, Ni, K, Mg, Ca, Mn, Fe, Al, and Si. In an instance, any one or more of the impurities is present at a concentration between about 0.5% and about 40% of the lithium concentration on a molar basis. In a preferred instance, the one or more impurities, aside from lithium, extracted from the black mass comprise cobalt, nickel, calcium, iron, magnesium, potassium, sodium, aluminum, silicon and manganese. Preferably, the one or more impurities is present at a concentration of less than 0.5% of the lithium concentration on a molar basis.

In another instance, the method or process can further include a concentration step d), wherein the technical grade lithium carbonate obtained in solution from step c) is concentrated. Preferably, the concentration step comprises standard concentration techniques of the art, including but not limited to: the addition of a concentrator, evaporation, reverse osmosis and/or electrodialysis, liquid-liquid extraction, selective adsorption and solid state extraction and/or membrane separation. Following the concentration step c), the lithium carbonate can be precipitated or crystallised from the solution. The method can further include a filtration step e), thereby to separate the precipitated lithium carbonate from a mother liquor. Notably, the method is adaptable and/or scalable to a continuous flow or batch-type scenario.

In an instance, the aqueous medium comprises water, one of more mineral acids, one or more organic acids, one or more alkaline salts, one or more ionic liquids, and combinations thereof. The one or more mineral acids can have a pH of about −1 to about 6. Preferably, the one of more mineral acids are optionally supplemented with a predetermined partial pressure of CO₂ between about 0.1 and about 300 bar; between about 1 and about 250 bar; between about 5 and about 225 bar; between about 10 and about 200 bar; between about 25 and about 175 bar; between about 50 and about 150 bar; between about 75 and about 125 bar; between about 80 and about 120 bar; between about 85 and about 115 bar; between about 90 and about 110 bar; or between about 95 and about 105 bar.

The one or more organic acids can be selected from acetic acid, formic acid, citric acid, lactic acid, oxalic acid, mixtures thereof, and the like. Preferably, the lithium salts extracted from the organic acid reaction medium are refined to form substantially pure lithium oxide or carbonate. The one or more mineral acids are optionally supplemented with a predetermined partial pressure of CO₂ between about 0.1 and about 300 bar (as defined above). In another instance, the one or more alkaline salts comprise alkali hydroxides, carbonates, bicarbonates and combinations thereof. Preferably, the one or more alkaline salts comprise lithium hydroxide, lithium carbonate, lithium bicarbonate and combinations thereof. In still another instance, the one or more alkaline salts are optionally supplemented with a predetermined partial pressure of CO₂ between about 0.1 and about 300 bar (as defined above). In still another instance, the one or more ionic liquids comprise protic and/or aprotic liquids. Preferably, the protic and/or aprotic liquids may be miscible or immiscible with water in the aqueous extraction medium. In another preferred instance, the one or more ionic liquids are optionally supplemented with a predetermined partial pressure of CO₂ between about 0.1 and about 300 bar (as defined above).

In another preferred instance, the lithium is obtained as lithium carbonate/bicarbonate, at a purity of about 85% on a molar basis. In other instances, the purity is about 50, 55, 60, 65, 70, 75, or 80% on a molar basis. In another instance, the impurities comprise nickel in an amount of about 5% and cobalt in an amount of about 1% on a molar basis. In other instances, the nickel may be present in about 1, 2, 3, 4, 5, 6, 7, 8, 9 or 10%. In other instances, the cobalt may be present in about 0.1, 0.2, 0.3, 0.4, 0.5, 0.6, 0.7, 0.8, 0.9, 1.0, 1.1, 1.2, 1.3, 1.4 or 1.5%.

In an especially preferred examples of the present invention, the CO₂ has a specific molar amount in water of about 3.7 mol/kg; the (predetermined) extraction temperature is about 150° C.; the (predetermined) pressure is about 100 bar; and the (predetermined) time is about 300 minutes (5 hours); accordingly, the reaction was observed to go to around 85% completion (i.e., extraction completion, based on the measured amount of lithium in the black mass)—and the observed impurities comprised K, Na, Ca, Mg, Mn, Fe, Al, Si, Ni, and Co. In some examples, lithium constituted ˜85% of the metals extracted from the sample, on a molar basis. In other examples, lithium constituted about 60% of the metals extracted from the sample, on a molar basis.

An additional purification step can be performed, the purification step comprising precipitating out at least some of the impurities from the technical grade lithium carbonate solution obtained in solution from step c).

Yet another embodiment is an apparatus for performing any one of the above described embodiments. The apparatus can include a) means for subjecting the black mass to an aqueous extraction medium defined by a reactor, a predetermined partial pressure of CO₂, a predetermined extraction temperature, and a predetermined residence time; and b) means for obtaining the one or more materials in solution therefrom. In an instance, the apparatus comprises a plurality of fluidised bed reactors arranged in fluid communication in series. In another instance, the apparatus comprises a plurality of fluidised bed reactors arranged in fluid communication in parallel. Preferably, the apparatus further comprises means for effecting an initial milling step, whereby the black mass is milled to a predetermined average particle size prior to being provided as the aqueous suspension. The apparatus can further include a means for concentrating the technical grade lithium carbonate obtained in solution following exposure to the extraction medium. The apparatus can still further include a filtration means, for filtering off any precipitated lithium carbonate following exposure to the concentration means. Herewith, the predetermined partial pressure of CO₂, the predetermined extraction temperature, the predetermined solids concentration and the predetermined time are as defined above in respect of the fourth and fifth aspects of the present invention.

### Examples

Products were prepared using standard GLP procedures for handling of the respective materials and admixtures. All commercial materials were used as received.

### Exemplary Process

Casings were removed from a plurality of NMC based lithium ion batteries and the cells were comminuted, thereby providing Shredded Battery Material (SBM). The SBM was mixed with supercritical CO₂ and water in a fluidised bed reactor, the temperature and pressure of the system was maintained at about 150° C. and 100 bar. Extract was removed from the system until the lithium concentration in the filtrate (extract) was below 10 ppm. About 90% of the lithium in the NMC based lithium ion batteries was recovered. Variations in the temperature and pressure of the system (from 100° C. to 200° C. and from 80 bar to 150 bar) provided analogous results. ICP analysis of residues in the fluidised bed reactor showed less than 10% of the original lithium concentrations.

### Additional Examples

The use of carbonic acid in the extraction of lithium from black mass was demonstrated on a laboratory scale. The black mass had not been pre-treated or concentrated by chemical or physical methods, and its original metallic loadings, including aluminum, remained as per a “raw” black mass of cathode materials. A 1 kg sample of milled black mass (sieved to lie in the size range ˜20 to ˜425 μm) was held in a fluidised bed reactor. A water flow of 1 g/min was passed through the reactor at a temperature of 150° C. and a pressure of 100 bar. The aqueous reactor effluent was sampled at regular intervals and analyzed for the presence of lithium and other metals extracted from the black mass charge.

With only water flowing through the reactor, a gradual release of lithium was observed. However, when CO₂ in the amount of 3.7 mol/kg water was also fed to the reactor, a relatively greater proportion of lithium surprisingly appeared in the product samples; the concentration of lithium in the product samples increased by a factor of 5 or more.

During optimisation experiments, the Inventors varied the temperature of the extraction medium between about 25 and about 200° C. The rate at less than about 100° C. is low; there was observed a large increase in rate in going to 150° C., but no further increase was observed upon raising the temperature to 200° C. Significantly, the purity of the extract is reduced significantly in going from 150 to 200° C.

The extraction of lithium from the milled black mass sample was about 60% complete after 1 h and about 90% after 2 h. Other metal ions detected in the extract were Al, Ca, Cr, Cu, Fe, Ga, K, Mg, Mn, Na, Si, V, Ni and Co. Overall, lithium constituted >92% of the metals extracted from the black mass sample, on a molar basis. The dominant impurity was nickel (about 5%), followed by cobalt (about 1%).

The reaction was also detectable in a batch reactor sparged with CO₂ at room temperature and atmospheric pressure.

TABLE 2
Extent of Li extraction from black mass
by carbonic acid over a 90 min period

| t (min) | Conc Li (mg/L) |
|---|---|
| 10 | 225 |
| 20 | 175 |
| 30 | 125 |
| 40 | 90 |
| 50 | 75 |
| 60 | 52 |
| 70 | 48 |
| 80 | 40 |
| 90 | 36 |

TABLE 3
Crystallographic characteristics of the available phases in the feed materials

| | Crystal | | α | β | γ | a | b | a |
|---|---|---|---|---|---|---|---|---|
| Phase | system | Reference | (°) | (°) | (°) | (Å) | (Å) | (Å) |
| Aluminum | Cubic | 98-005- | 90 | 90 | 90 | 4.049 | 4.049 | 4.049 |
| | | 2255 | | | | | | |
| Lithium nickel | Hexagonal | 98-009- | 90 | 90 | 120 | 2.871 | 2.871 | 14.171 |
| cobalt oxide | | 9871 | | | | | | |
| Lithium cobalt | Hexagonal | 98-008- | 90 | 90 | 120 | 2.88 | 2.88 | 14.227 |
| manganese oxide | | 4957 | | | | | | |
| Lithium cobalt | Hexagonal | 98-017- | 90 | 90 | 120 | 2.86 | 2.86 | 14.227 |
| nickel manganese | | 1750 | | | | | | |
| oxide | | | | | | | | |

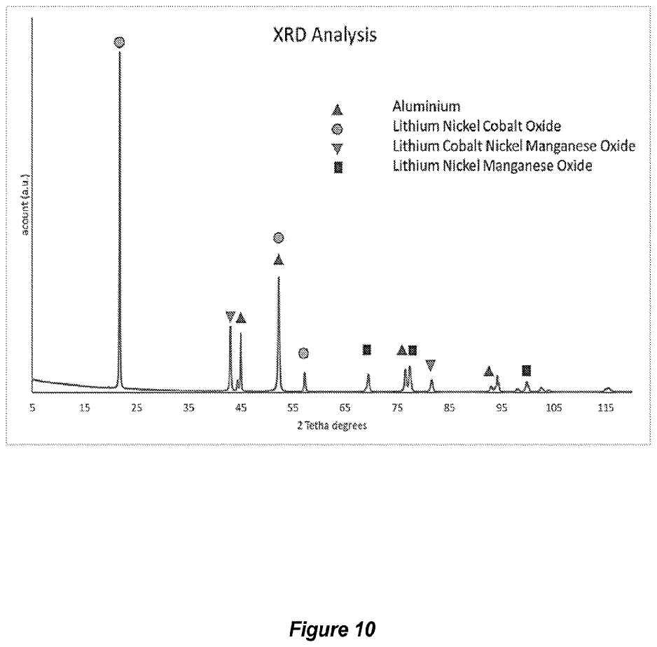

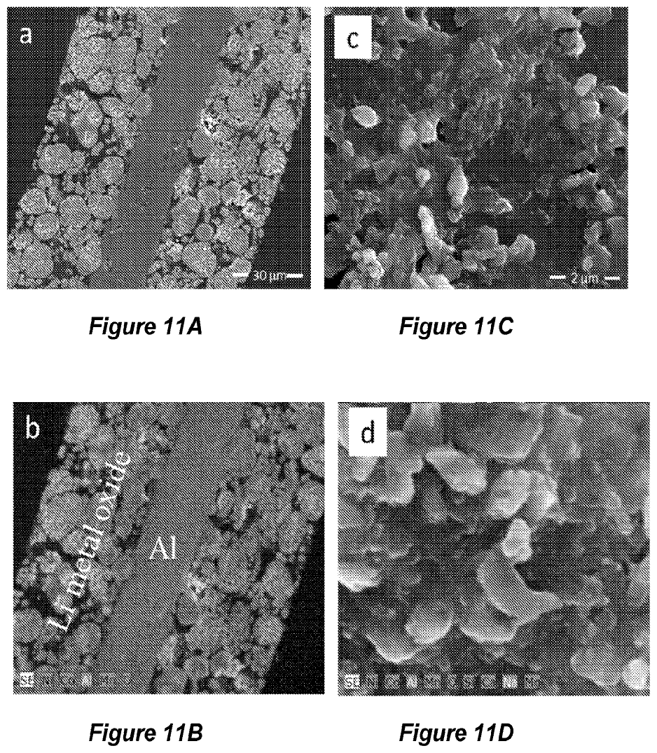

The data presented in Table 3, above, should be read in conjunction with FIG. 10, which shows the crystal structure of cathode materials determined by X-ray diffraction (XRD) analysis. By referring to the XRD patterns of the standard samples listed, all diffraction peaks could be indexed to four different phases. The high intensity peaks are in good agreement with the standard data suggesting that the two main phases could be aluminum and lithium nickel cobalt oxide.

TABLE 4
The elemental characteristics of the cathode materials
analyzed using Inductively Coupled Plasma Optical
Emission spectroscopy (ICP-OES).

| Element | Conc. (mg/kg or ppm) |
|---|---|
| Al | 183947.3173 |
| Ca | 51.7811 |
| Co | 67896.0031 |
| Cu | 49.7751 |
| Fe | 931.2073 |
| Ga | 27.8966 |
| Li | 49200.0389 |
| Mg | 15.3769 |
| Mn | 4.7628 |
| Na | 9.1352 |
| Ni | 381502.7216 |
| V | 28.9745 |

Table 4 shows the elemental analysis of the Li-bearing materials processed according to the present invention. The data reveal that aluminum, lithium, nickel and cobalt are in high concentration which is in good agreement with the phases identified by XRD analysis, thereby confirming that aluminum and lithium nickel cobalt oxide could be the main components of the sample.

Table 4 further indicates that there remain other impurities alongside the main elements that have not been extracted through this process. These impurities are most likely calcium, copper, iron, gallium, magnesium, manganese, sodium and vanadium.

The general method employed above amply demonstrates that the use of carbonic acid as an extraction medium for lithium carbonate from black mass is surprisingly efficacious. As rationalised above, this finding is completely counter-intuitive given the prevailing state of the art in which strong acids and pre-treatment are the currently-preferred industrial methods for the extraction of lithium from black mass.

The methodology further demonstrates the efficacy of carbonic acid as an extraction medium for other precious metal recycling from black mass. Such metals may include any one or more of Ag, Au, Al, Ca, Cr, Cu, Fe, Ga, K, Mg, Mn, Na, Si and V. These may be selectively extracted with the use of chelating agents selected from one or more of tri-n-butyl phosphate (TBP), nitric acid, sodium hydroxide, hydrogen peroxide, diethanolamine (DEA), 2-ethylhexyl phosphonic acid-mono-2-ethylhexyl ester, mono-2-ethylhexyl(2-ethylhexyl)phosphonate (PC88A), di-(2-ethylhexyl)phosphoric acid (D2EHPA), bis(2,4,4-trimethylpentyl) phosphinic acid (Cyanex 272), or bis(2,4,4-trimethylpentyl) dithiophosphinic acid (Cyanex 301).

While the compositions and methods of this invention have been described in terms of preferred instances, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. A process for separating lithium from lithium ion batteries before undertaking hydrometallurgical or pyrometallurgical processing, the process comprising:
providing a black mass (BM) or shredded battery material (SBM) that includes cation and anion components;
commixing the BM or SBM with an admixture that includes water and supercritical carbon dioxide; and
separating an aqueous leachate and a lithium-leached BM or SBM, where the aqueous leachate includes a lithium carbonate and/or bicarbonate.

2. The process of claim 1, wherein providing the BM or SBM includes providing lithium ion batteries;
mechanically shredding the lithium ion batteries to produce a BM or SBM; and optionally
mechanically separating casing materials from the BM or SBM.

3. The process of claim 1, wherein the BM or SBM includes at least two of shredded cathode material, shredded anode material, electrolyte salts, and solid electrolyte interphase (SEI) material.

4. The process of claim 3, wherein the BM or SBM includes SEI material.

5. The process of claim 3, wherein the BM or SBM includes shredded cathode material and shredded anode material.

6. The process of claim 1, wherein the BM or SBM includes a lithium mass; and wherein the aqueous leachate includes at least 75% of the lithium mass.

7. The process of claim 1, wherein SBM is used in the process.

8. The process of claim 1, wherein BM is used in the process.

9. The process of claim 1 further comprising crystallising lithium carbonate from the aqueous leachate.

10. The process of claim 1, wherein the lithium-leached BM or SBM is substantially free of lithium.

11. The process of claim 1, wherein the lithium-leached BM or SBM includes less than 25% of the lithium included in the BM or SBM.

12. The process of claim 1, wherein the BM or SBM and the admixture that includes water and supercritical carbon dioxide are commixed at a predetermined extraction temperature and a predetermined partial pressure for a predetermined residence time.

13. The process of claim 1, wherein the BM or SBM and the admixture that includes water and supercritical carbon dioxide are commixed at a temperature of about 80° C. to about 200° C. and at a pressure of about 70 bar to about 250 bar.

14. The process of claim 1, further comprising hydrometallugically separating nickel from the lithium-leached BM or SBM.

15. The process of claim 1, further comprising pyrometallugically separating nickel from the lithium-leached BM or SBM.

16. A process comprising:
comminuting a plurality of lithium-ion cells in water thereby providing a slurry that includes a black mass (BM) or shredded battery material (SBM) and water;
commixing the slurry with supercritical carbon dioxide; and
separating an aqueous leachate and a lithium-leached BM or SBM, where the aqueous leachate includes a lithium carbonate and/or bicarbonate.

17. The process of claim 16, wherein the process is continuous.

18. The process of claim 13 further comprising
crystallising lithium carbonate from the aqueous leachate; and
separating the crystallised lithium carbonate from the aqueous leachate.

19. The process of claim 16, wherein the plurality of lithium-ion cells are comminuted in a mixture of the aqueous leachate and water.

20. The process of claim 16, wherein a supercritical carbon dioxide phase is separated from the slurry, where the supercritical carbon dioxide phase includes at least one of an organic electrolyte and an organic polymer.

21. The process of claim 19, wherein the organic electrolyte includes at least one of ethylene carbonate, fluoroethylene carbonate, propylene carbonate, and glycol.

22. The process of claim 19, wherein the organic polymer includes a separator polymer and/or binder.

23. The process of claim 16, wherein the plurality of lithium-ion cells are comminuted in an admixture of water and carbon dioxide, thereby providing a slurry that includes a shredded black mass (BM) or battery material (SBM), water, and carbon dioxide.

24. A process comprising:
comminuting a plurality of lithium-ion cells in a solution of water and carbon dioxide thereby providing a slurry that includes a black mass (BM) or shredded battery material (SBM), lithium bicarbonate, water, and carbon dioxide; and
separating an aqueous leachate from the BM or SBM, where the aqueous leachate includes the lithium bicarbonate.

25. The process of claim 24, wherein the solution of water and carbon dioxide is substantially free of oxygen.

26. The process of claim 24, further comprising
commixing the slurry with supercritical carbon dioxide; and
separating an aqueous leachate and a lithium-leached BM or SBM, where the aqueous leachate includes a lithium carbonate and/or bicarbonate.

27. The process of claim 24, further comprising
commixing the BM or SBM with a second solution that includes water and supercritical carbon dioxide; and then
separating an aqueous leachate and a lithium-leached BM or SBM, where the aqueous leachate includes a lithium carbonate and/or bicarbonate.
